(19) United States
(12) Patent Application Publication
(10) Pub. No.: US 2012/0287487 A1
(43) Pub. Date: Nov. 15, 2012

(54) SYSTEM AND METHOD FOR DETERMINING SCAN LIMITS WITH CONTROL TIERS AND AUTOMATICALLY SCANNING DOCUMENTS ACCORDING TO SAME

(75) Inventor: Ramesh NAGARAJAN, Pittsford, NY (US)

(73) Assignee: XEROX CORPORATION, Norwalk, CT (US)

(21) Appl. No.: 13/105,593

(22) Filed: May 11, 2011

(51) Int. Cl. H04N 1/46; H04N 1/04

(52) U.S. Cl. 358/505; 358/474

(57) ABSTRACT

Disclosed is a method and a system for automatically scanning documents based on at least a user's credentials. The user's credentials are used to select a highest tier (from a plurality of tiers) for scanning the image data, and the image data is scanned according to the selected highest tier. Alternatively, if the highest tier selected is not authorized by a user's credentials, then a next highest tier is selected in accordance with the credentials, and then the job is automatically scanned. The credentials may be based on a time period (e.g., time of day), bandwidth, or a user's authorization (e.g., to scan color documents), for example. The tiers may be based on one or more thresholds, such as a percentage of color content in a document or scan resolution.

### BACKGROUND

1. Field

The present disclosure is generally related to scanning documents. More specifically, the present disclosure is related to automatically scanning documents at the highest tier allowed based on a customer's profile.

2. Description of Related Art

One barrier to the adoption of color document scanning within offices is the inability to conveniently control and/or limit color usage or high resolution scans by users (e.g., for cost purposes). Some enterprise and cost conscious customers would like to restrict usage of color and/or high resolution scanning within their environments. In some systems or products, feature access control is provided whereby certain features (such as use of color) are enabled (or disabled) based on user's credential(s). In some instances, levels or tiers are used to categorize and/or control output of image data. For example, only specific users may be authorized for (or limited from) color scanning (e.g., authorized at a first tier), while others are not (e.g., authorized at a second tier). However, such limitations generally only apply to 2-tier models, i.e., a user is merely limited to scanning in black & white or color (e.g., yes or no). Therefore models with three or more tiers that offer several levels of color impressions (e.g., black and white, everyday color, expressive color) are underutilized.

Some methods attempt control color and/or high resolution scans. However, in many instances, controller decisions may delete a user's job if his/her credential(s) do not meet the requirements. For example, after a user's scan selections are submitted, the user's credentials may be analyzed for authorization to scan using such selections. If the user is authorized to do so, the job could be scanned. If not, the job would be deleted.

Accordingly, an improved system and a method for determining a user's color or scan limits (or credentials) with a tiered process and automatically scanning documents according to a user's credentials is desirable.

### SUMMARY

One aspect of the disclosure provides a method for automatically scanning documents having at least one page for a specified user using an image processing apparatus, the image processing apparatus including an image input terminal for scanning documents into image data and a processor for processing documents containing image data having a plurality of pixels. The processor is configured to perform the method including:

receiving credentials for a specified user;

selecting a highest tier for scanning image data from a plurality of tiers and based on credentials for the specified user, each tier being based on at least one predetermined threshold, and

scanning the image data according to the at least one predetermined threshold of the selected highest tier using the image input terminal.

If scanning at the selected highest tier is unauthorized or insufficient based on the credentials, then the method further includes:

selecting a next highest tier using the processor from the plurality of tiers for scanning the image data that is authorized and based on the authorization of the credentials, and

scanning the image data of the document according to the at least one predetermined threshold of the selected next highest tier using the image input terminal; or

determining an authorized time of day for scanning the image data at the selected highest tier, and

providing the authorized time of day to the user.

In another aspect of the disclosure, provided is a system for automatically scanning documents having at least one page for a specified user. The system includes an image input terminal for inputting documents as image data and processor for processing documents containing image data comprising a plurality of pixels. The processor is configured to:

receive credentials for a specified user;

select a highest tier for scanning image data from a plurality of tiers and based on credentials for the specified user, each tier being based on at least one predetermined threshold, and

scan the image data according to the at least one predetermined threshold of the selected highest tier using the image input terminal.

If scanning at the selected highest tier is unauthorized or insufficient based on the credentials, then the processor is further configured to:

select a next highest tier using the processor from the plurality of tiers for scanning the image data that is authorized and based on the authorization of the credentials, and

scan the image data of the document according to the at least one predetermined threshold of the selected next highest tier using the image input terminal; or

determine an authorized time of day for scanning the image data at the selected highest tier, and

provide the authorized time of day to the user.

Other features and advantages of the present disclosure will become apparent from the following detailed description, the accompanying drawings, and the appended claims.

### BRIEF DESCRIPTION OF THE DRAWINGS

FIG. 1 illustrates an exemplary flow chart/block diagram illustrating a method for automatically scanning documents comprising at least one page for a specified user using an image processing apparatus or system in accordance with an embodiment.

FIG. 2 illustrates an exemplary flow chart/block diagram of a method for automatically scanning documents based on a selected tier from a plurality of tiers, in accordance with an embodiment.

FIG. 3 illustrates an exemplary block diagram of image path of a system, device or image processing apparatus, in accordance with an embodiment, comprising at least a processor and an image output terminal, for scanning documents using the method of FIG. 1.

FIG. 4 illustrates an alternate blocks in the method of FIG. 2 in accordance with an embodiment.

### DETAILED DESCRIPTION

In order to further increase color scanning in the marketplace, this disclosure proposes a way to automatically enforce color usage and/or scan usage limits based on user credentials. “Scanning” refers to recording of an image or document as digital data, and may be performed using any number of devices or machines, such as a scanner. A “document” can include any set of related images or data. A user's credential(s) that are submitted will be used to automatically input image data of a document (i.e., scan) to the maximum tier possible for his/her credentials. In this case, a “tier” refers to a level or category that is used to categorize or control input or received image data based on user credentials. Document(s) that are “automatically” scanned refer to inputting image data without user interaction or input, based on received credentials. For example, when credentials and input parameter(s) are submitted for scan using an output device, the image data of the document is input such that the document is scanned at its highest possible quality (e.g., using the most color possible) for that specific user. For example, as is further described below, if a user is authorized to make first tier and second tier scans using an image processing apparatus, and he/she submits a job that is marked for third tier scanning, then the document(s) in the job will be automatically scanned at the second tier level. This provides an improved alternative to known systems which may typically require (further) user input and/or which may delete a job altogether.

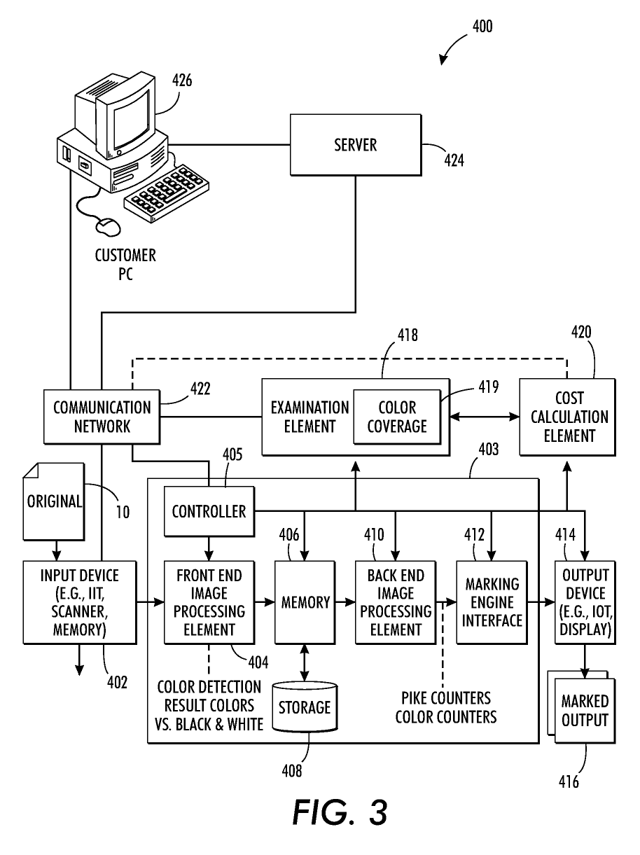

Generally, in systems/devices (e.g., printers, copiers, or multi-function devices or printers (MFDs), such as the system shown and described with reference to FIG. 3), when a document is to be input, it is scanned by an input device or retrieved from memory or storage. Thereafter, the image data is processed in an image path based on black and white (or gray) pixels of image data, i.e., no significant color image data in one or more color planes, or color pixels. “Processing” refers to storing and/or performing an operation on digital image data for any purpose, and may include for the purpose of marking and/or outputting image data. The image may optionally be output.

The method(s) or device(s) used to determine the type of image for input in this disclosure should not be limiting.

In accordance with an embodiment, scan sets or control tiers may be used to categorize features of input images (and possibly any costs associated with outputting images). Such scan sets or tiers may be determined and/or selected based on the type of image and input parameter(s). “Input parameter(s)” are defined as features used to scan images. For example, as generally known in the art, increasing a scan resolution of an input device can result in greater detail, more pixels, a larger file size, and better quality input images (and, therefore, higher quality output images). “Scan resolution” is defined as an amount of dots per inch (DPI), pixels per inch (PPI), or samples per inch (SPI) that are measured (e.g., using sensors) during scanning of an image or document. Scan resolution may be an input parameter that is used to define scan tiers. Additionally, since users like to print documents in expressive, useful, and everyday color, they may be inclined to scan documents in color as well. Scan tiers may be based on any number of input parameters and should not be limiting.

In an embodiment, three scan sets or control tiers may be provided. For example, in an embodiment, three tiers may be defined as follows: First tier: all black and white documents and documents with a small amount of color; Second tier: documents with more than a small amount of color but less than a large amount of color (everyday color, level 2 impressions); and Third tier: documents with large amounts of color (expressive color, level 3 impressions). In some embodiments, input parameters and/or scan tiers may be based on input parameters offered by a particular machine or device.

To determine or separate such tiers, break-points or thresholds may be used. In an embodiment in accordance with this disclosure, the thresholds dividing the scan tiers may be based on one or more parameters.

In an embodiment, the thresholds dividing the tiers is based on a user input selection for scanning a document (i.e., the user may manually select a tier for scanning a document). A user may input a tier selection for scanning based on the type of data to be scanned by the machine for scanning (e.g., a scanner or a system with scanner for printing the pages) either directly into the machine or indirectly (e.g., remotely). The selections for scanning may be based on or correspond to the scan tiers, e.g., first tier (Level 1), second tier (Level 2); and third tier (Level 3). In an embodiment, each tier can comprise one or more selections for scanning. For example, in an embodiment, the parameter(s) for dividing the tiers is based on an amount of color in a document and/or a resolution for scanning a document.

In an embodiment, each scan tier is divided using a threshold based on an amount of color (i.e., selected by the user) in the document for input. For example, a document may include objects such as monochrome contone objects, monochrome text objects, monochrome line art, monochrome graphic objects, monochrome halftone objects, monochrome solid fill objects, color contone objects, color text objects, color line art objects, and/or color solid fill objects. Monochrome text objects and/or Monochrome line art may be a Level 1 selection, color line art objects a Level 2 selection, and color solid fill objects a Level 3 selection. The user may determine an input scan selection based on their respective determination of the type of data to be scanned by the machine.

In another embodiment, the thresholds dividing the tiers are based on a percentage of color in a document. For example, the thresholds may include approximately 3% and approximately 10% color coverage. If a page has an amount of color coverage that is below or equal to approximately 3%, the first tier is used for scanning. If greater than approximately 3% but less than or equal to approximately 10%, tier-2 is used for scanning. Otherwise, i.e., if the amount of color coverage is greater than approximately 10%, the page is scanned using tier-3. In an embodiment, the percentage thresholds may be approximately 1.5% and approximately 8%.

In an embodiment, the percentage of color coverage of a page (or document) may be determined based on a number of selected input parameter(s). For example, the type of data selected for scanning (e.g., by a user) may determine an amount of color coverage.

In yet another embodiment, each scan tier is divided using a threshold based on a resolution for scanning the document for input. For example, based on the types of objects included in a document (e.g., color solid fill objects, monochrome text objects), a user may select a higher or lesser resolution for scanning. Scanning at 300×300 may be a Level 1 selection, scanning at 400×400 may be a Level 2 selection, and 600×600 may be a Level 3 selection. The user may determine an input scan selection based on their respective determination of the type of data to be scanned by the machine.

In yet another embodiment, the scan tiers may be based on two or more parameters. For example, each scan tier may correspond to an amount of color in a document and a scan resolution. A Level 1 document may be scanned at Tier-1 at 300×300 resolution, a Level 2 document may be scanned at Tier-2 at 400×400 resolution, and a Level 3 document may be scanned at Tier-3 at 600×600 resolution.

Alternatively, in another embodiment, scan resolutions and/or color amounts for defining tiers may be altered—separately or together—on a per device usage, per input document, and/or per user bases.

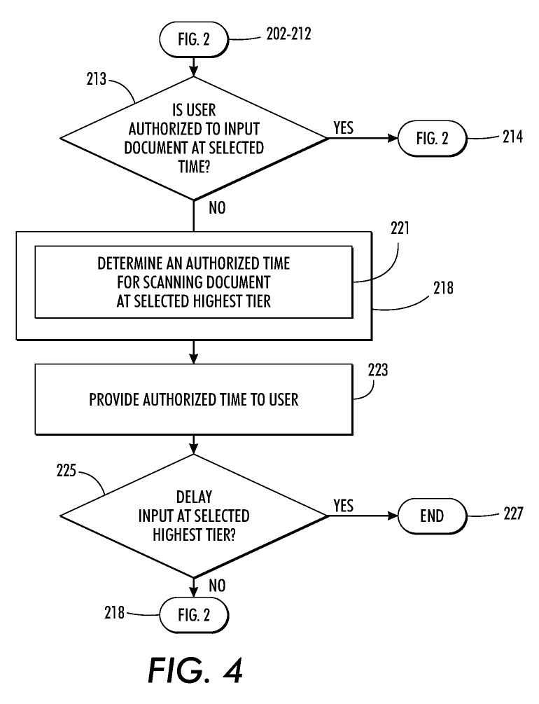

However, the threshold value(s) and the methods of defining the threshold value(s) that are used to determine the scan tiers should not be limiting. Additionally, any number of tiers (i.e., N-tiers) may be used. For example, four (4) or more tiers may be used. In an embodiment, the number of tiers for scanning may also or alternatively be defined by a type of output device selected for output. For example, if a user selects to output the scanned document to a machine capable of outputting multiple colors (including black) or capable of high graphic output, more tiers (and/or thresholds) may be provided for inputting a document. Alternatively, if a user selects a machine capable of outputting only one or two colors (including black), less tiers (and/or thresholds) may be provided. In some embodiments, depending on the output device or system (e.g., MFD) used, the color level impressions/scan resolutions for input may be defined differently. For example, in a possible practical embodiment, Level 2 impressions for these devices may include a combination of the exemplary above-defined Level 2 Impressions+Level 3 Impressions. As such, the selection and break-points/thresholds for defining tiers should not be limited to the examples provided herein. Various other multi-tiered strategies or thresholds are also envisioned. Exemplary output devices are further described below with reference to FIG. 4.

Throughout this disclosure, for explanatory purposes only, it is to be understood that a progressive indication of tiers—e.g., first tier, second tier, third tier—indicates a progressive amount of scanning for a document, i.e., scanning costs at tier-2 are higher than those at tier-1, scanning costs at tier-3 are higher than those at tier-2 and tier1, etc. Also, it is to be understood that an amount of color in a document (that is used to determine the tiers, for example) as used throughout this disclosure is not limited just to an amount of color that is visible to the human eye when the document is output. For example, the amount of color may refer to an amount of colorant (ink or toner) used for marking and output. It is to be understood that an amount may refer to a percentage, ratio, and the like.

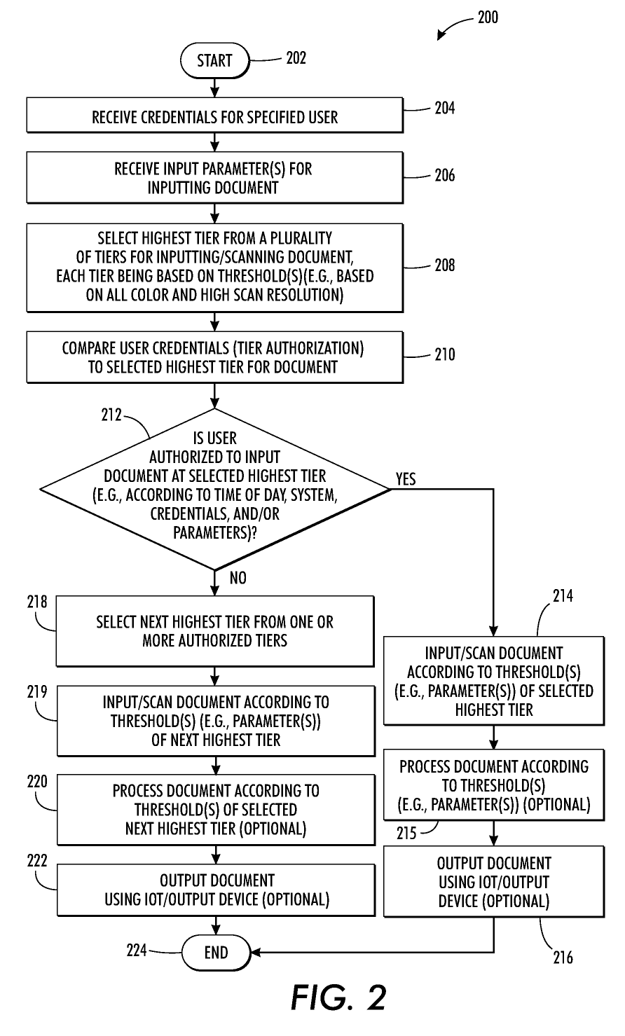

Although throughout this disclosure it is noted that each tier comprises at least one predetermined threshold, tiers may be selected based on one or more thresholds, resolutions, or algorithms, for example. In an embodiment, the at least one predetermined threshold associated with each tier is defined by one or more percentage amounts of color in an input document. For example, a range of percentages may be used for each tier. In another embodiment, the at least one predetermined threshold associated with each tier is defined by a scan resolution for an input document. For example, a range of dots per inch may be used as a threshold for each tier. Exemplary embodiments using percentage amounts of color/scan resolution as a threshold are described in more detail below and with reference to FIG. 2.

The method and the system disclosed herein may identify alternative image quality/formatting options (e.g., less color usage or scan resolution) and automatically process the document with the alternative options in order to adjust (e.g., downgrade) the scan tier according to the user's credentials (e.g., from third tier to second tier). Thus, the document can be inputted and scanned without forcing the user to input or set multiple imaging parameters.

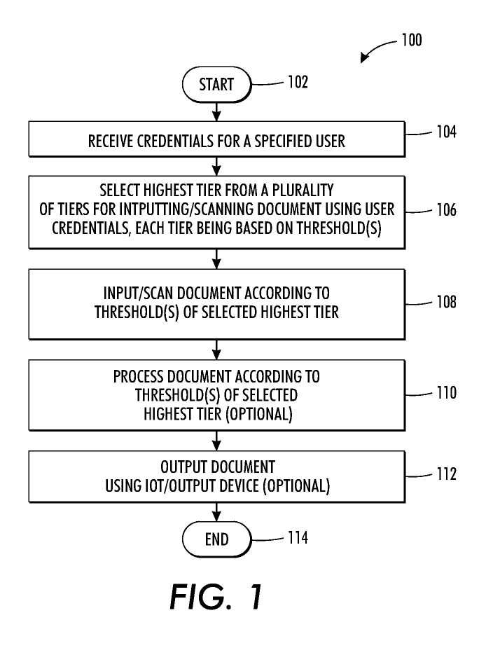

FIG. 1 illustrates an exemplary flow chart/block diagram illustrating a method 100 for automatically scanning documents comprising at least one page for a specified user using an image processing apparatus or system, in accordance with an embodiment. As shown in FIG. 3, the system or image processing apparatus comprises and an image input device (e.g., input terminal) for inputting documents as image data and at least one processor for processing documents containing image data comprising a plurality of pixels. A controller may also work in cooperation with input device and/or processor(s). At least the one processor is configured to perform the method 100 of FIG. 1. In an embodiment, the input device may comprise the at least one processor and/or a controller for implementing the method 100.

Specifically, the method 100 begins or starts at block 102. At block 104, credentials for a specified user are received (e.g., input at input device, system, or remotely connected computer). At block 106, a highest tier from a plurality of tiers is selected for inputting or scanning the document. The selected highest tier is based on the credentials for the specified user. For example, as noted above, each tier is based on at least one predetermined threshold. The threshold may be based on an input amount of color in a document or an input scan resolution. In an embodiment, the amount of color in the document/scan resolution as well as the credentials (e.g., authorization) may be used to select the highest tier for the scanning the document.

Then, at block 108, the image data of the document is inputted or scanned using the input device according to the at least one predetermined threshold of the selected highest tier. Optionally, thereafter, the processor(s) can then process the image data of the document for output and then output using the image output terminal, as shown at blocks 110 and 112. For example, after scanning a document using a color scanner at a 600×600 dpi, the image data may be automatically processed and output (e.g., output to a network). The method ends at block 114.

As previously noted, the credentials may be used to determine one or more tiers at which a document may be inputted (scanned) for a specific user. Accordingly, they can also determine how image data is processed (e.g., see blocks 106 and 108 of FIG. 1).

In an embodiment, credentials for a specified user may be received before the image data of the document is received as shown at block 104 in FIG. 1. For example, a user may input the credentials directly (e.g., via an interface that retrieves data from a directory or storage device of a system or machine) or indirectly (e.g., from a storage device via a network) to a system and/or image processing apparatus, and the credentials are received for the at least one output job. That is, credentials may be associated with a specific output (print) job, or associated with a number of output jobs (e.g., until a user logs out or signs out).

Alternatively, in another embodiment, the credentials may be read from a separate document (e.g., a scanned document) or an access device, such as a card. In the first example, a header of a document may include user credentials, profile, or similar identification information for retrieval. For example, a first page (e.g., cover page) containing user credentials may be scanned before the document itself is scanned. In the second example, a card may be inserted to be read by a device associated with the machine itself or by another device to which credentials are then communicated to the machine before scanning the document. In some of embodiments, including those not specifically mentioned here, once credentials are received, the apparatus or system can perform a lookup and determine if the user exists and/or what the user's credentials are (e.g., able to print color, able to cover costs), before allowing inputting or scanning of a document.

Throughout this disclosure, “credentials” are defined as an authorization, authentication, or a right to scan privileges. In particular, credentials define a user's right to scan at particular resolutions for documents containing color and/or high level impressions (such as Level 3 impressions, e.g., solid fill objects, photographs, etc.). Credentials may include a predetermined set of conditions for scanning image data. In some embodiments, credentials may also include a predetermined set of conditions for processing and/or outputting image data. Credentials are used to determine the one or more tiers at which a user can input (scan) documents. For example, in an embodiment, the credentials of a user comprises appropriate color usage limits (e.g., authorization (based on seniority) to scan at one or more predetermined tiers), and may define the authorization to scan at a related level or tier. In another embodiment, for example, credentials may be defined by an amount of credit available in a user's account. In yet another embodiment, the credentials may include information related to authorization of a user to output at a corresponding (billing or control) level or tier, as referenced by the incorporated '002 application noted below. The credentials of each user may be customized and adjusted in any number of ways.

For example, in an embodiment, one predetermined threshold for each scan tier (e.g., Tier-1, Tier-2, Tier-3) is an amount of color in the document (or page), and the credentials of the profile show that a user may scan at level one and level two color impressions (i.e., documents determined having a Tier-1 or a Tier-2 structure). If the user inputs a document that has level three color impressions and selects to scan the document at Tier-3, the processor may initially determine and select the scan tier for the document as Tier-3. However, since the credentials limit input to Tier-1 and/or Tier-2, a next highest scan tier will be selected (i.e., a Tier-2 scan tier (level two color impressions) for scanning the document. Optionally, the image data may then be processed and output by the apparatus. Thus, in this exemplary embodiment, processing the image data may also comprise altering scan features for inputting the document. Such alteration of the image data/input document may include scanning pixels of image data using lesser range of color, and/or scanning pixels of image data using a lesser resolution.

FIG. 2 illustrates an exemplary flow chart/block diagram illustrating a method 200 for automatically inputting documents using an image processing apparatus or system, in accordance with the above-described embodiment, i.e., the user's credentials comprise authorization for scanning documents at one or more predetermined tiers. For example, authorization(s) or restriction(s) on color scanning may be based on seniority in the workplace or workflow. Additionally or alternatively, authorization (or restriction) may be based on a time of day that a device is being used for scanning or based on a type of device selected for scanning. The method(s) or feature(s) used to determine authorization should not be limiting.

Also, for explanatory purposes only in this exemplary embodiment, the at least one predetermined threshold for each tier is based on a range of percentage amounts of color in the document and a scan resolution. For example, in this embodiment, each tier may be selected based on a selected amount of color for input (e.g., Level 2 impressions, Level 3 impressions), and the selected amount corresponds to a predetermined scan resolution, or vice versa (e.g., a selected scan resolution corresponds to a selected amount of color for input). In an embodiment, for example, the range of percentages for the tiers may comprise ˜0 to ˜1.5% (Tier-1), ˜1.5 to ˜8% (Tier-2), and ˜8% or greater (Tier-3), with respective scan resolutions of 300×300, 400×400, and 600×600.

Like method 100, method 200 of FIG. 2 begins or starts at block 202, and at block 204 credentials for a specified user are received by the processor(s) (or system or apparatus). Credentials may be received at 204 via user input at the machine location (e.g., using a keypad) and/or via input delivered remotely to the machine (received by the processor via communication with a machine at which credentials are input). Then, at block 206, input parameter(s) for inputting a document are received. Input parameter(s) may also be received at 206 via user input at the machine location (e.g., using a keypad) and/or via input delivered remotely to the machine (received by the processor via communication with a machine at which credentials are input).

Based on the credentials and input parameter(s) received, a processor initially (or originally) selects at block 208 the highest tier from a plurality of tiers for inputting or scanning a document. Each tier may be based on at least one predetermined threshold, such as a range of percentage amounts of color and/or a scan resolution described above, for a particular device or machine. For example, in an embodiment, the highest tier may be a tier at which the image data is input with its highest percentage amount of color, at its highest quality (e.g., all colors and color spaces (including black/grayscale), and/or with the highest scan resolution for scanning pixels of image data. At block 210 a user's credentials i.e., authorization for outputting at specific tiers, are compared to the initially selected highest tier for input of the document (as determined at block 208). That is, the comparison determines if the authorization at the one or more predetermined tiers in the user's credentials allows for input or scanning of the document at the initially selected highest tier associated with the machine. If the user is authorized to input documents at the initially selected highest tier in block 212, i.e., YES, then the image data is input or scanned at block 214 (using an image input terminal of the device or machine) according to at least the one predetermined threshold of the selected highest tier.

Optionally, the scanned document may then be processed at block 215 according to threshold(s) (which may or may not correspond to the input parameter(s)), and may (optionally) be output at block 216 (e.g., using an output device). In accordance with some embodiments, the image data may also be (optionally) processed and output further based on a user credentials. For example, in addition to limiting a tier at which image data is inputted and/or scanned, the disclosed method and system may further include processing the image data based on tier levels and/or user credentials, such as is disclosed in U.S. application Ser. No. 12/941,002, filed Nov. 5, 2010, and assigned to the same assignee (Xerox Corporation), which is hereby incorporated by reference in its entirety. For example, after implementing the methods disclosed herein, the processor(s) may be further configured to process the image data with the processor(s) such that an amount of output color pixels is limited, an amount of colorant (ink/toner) used for marking and outputting the document is limited, etc. depending on the user's credential(s). In some embodiments, the number of scan tiers may affect the number of billing tiers, or vice versa. In some embodiments, the scan tiers and billing tiers may be separately defined. It should also be understood by one of ordinary skill in the art that additional processing steps may be applied to pixels of image data of a document to be output to meet restrictions and/or constraints of the credentials and/or tiers.

The method 200 ends at block 224.

If, however, the user is not authorized to input or scan a document at the initially selected highest tier (based on the comparison of the user's credentials) at block 212, i.e., NO, then a next highest tier is selected by the processor from the plurality of tiers based on the one or more authorized tiers indicated by the user's credentials at block 218. In an embodiment, the selection of the next highest tier at block 218 comprises selecting a tier for scanning the image data of the document using a tier with a lesser range of percentage amounts of color than the range of percentage amounts of color in the highest tier for inputting the image data. For example, the highest tier may comprise a first range of percentage amounts of color—e.g., ˜8%—and the next highest tier may comprise a second range of percentage amounts of color—e.g., ˜1.5% to ˜8%. In another embodiment, the selection of the next highest tier at block 218 comprises selecting a tier for scanning the image data of the document using a tier with a lesser resolution than a resolution in the highest tier for inputting the image data. For example, the highest tier may comprise a first resolution—e.g., 600×600—and the next highest tier may comprise a second resolution—e.g., 400×400. In yet another embodiment, the selection of next highest billing tier comprises selecting a lesser range of percentage amounts of color and a lesser resolution for inputting the document.

After the next highest tier is selected at block 218, the image data is automatically scanned (without user intervention, and scanning parameters being adjusted, as necessary) according to the at least one predetermined threshold of the selected next highest tier (e.g., lesser percentage amount of color), as noted at block 219.

The image data of the document is then optionally processed at block 220 according to threshold(s) of the selected next highest tier (which may or may not correspond to the input parameter(s)), and may (optionally) be output at block 222 (e.g., using an output device), as described above. The method ends at 224.

Again, the input of image data of a document at the next highest tier should not be limited to a percentage amount of color and/or a scan resolution. For example, in an embodiment, processing the image data of the selected next highest tier may comprise, either in addition to or alternative to, one or more of the following steps: adjusting hues of colors of the image data, adjusting sharpness of pixels of the image data, adjusting contrast between pixels of the image data, and/or adjusting saturation levels of one or more colors. Additionally, the at least one predetermined threshold for each tier should not be limited to a percentage amount of color and/or scan resolution. In an embodiment, a predetermined threshold is a saturation level of color.

In another embodiment, the user credentials used to determine one or more tiers at which a document may be input for a specific user are based on time. For example, the predetermined threshold for each tier (e.g., Tier-1, Tier-2, Tier-3) may be an amount of color in the document (or page) and a scan resolution, and the credentials of the profile show that a user has authorization to scan at one or more predetermined tier(s) based on a time of day. A user's credentials may indicate authorization (or limitation) for selection and scanning at a highest tier and/or selection and scanning at the next highest tier is based on: a current time period selected from a plurality of predetermined time periods, a time of day, a day of the week, and a current network bandwidth.

As such, if the user's credentials include authorization time(s), the system and/or processor is configured for such a consideration. FIG. 4 illustrates such an embodiment showing alternate blocks with references to method 200 of FIG. 2. For example, block 212 may comprise and/or include block 213 to determine if a user is authorized to input a document at the selected highest tier at a time of day (or other time parameter). If YES, then the method may proceed at block 214 and the document is scanned according to the at least one predetermined threshold(s) (and optionally blocks 215, 216, and 224). If, however, the comparison at block 213 results in scanning being unauthorized for scanning of the image data at the selected highest tier because the time of day (or other time parameter) is unauthorized, i.e., NO, then the selection of the next highest tier at block 218 comprises determining an authorized time of day for scanning the image data at the selected highest tier, as shown by block 221 in FIG. 4. Thereafter, the method 200 would not proceed to block 219 as shown in FIG. 2, but rather to block 223. At block 223, the processor provides the authorized time of day for scanning at the selected highest tier to the user. For example, the time of day (or other authorized time) may be provided via a screen on the device or machine, a user interface, a computer, or a communication transmission.

In an embodiment, the user may decide to delay scanning of the document until the authorized time, i.e., YES, at block 225, and the method ends at 227. In another embodiment, the user may decide to forego scanning at the selected highest tier (e.g., as determined at block 208) at block 225, i.e., NO. In an embodiment, the processor may receive instructions (e.g., via user input) to proceed with the method at block 218 in FIG. 2 by selecting a next highest tier from one or more authorized tiers by determining and selecting alternate parameters for scanning the document (e.g., with lesser range of color or lesser resolution) and scanning the document at block 219.

In another embodiment, the color and scan resolution may be separate input parameters. Credentials may define a user's authorization for inputting image data in little or no color, some color, or full color, for example. Credentials may define a user's authorization for inputting image data at a predetermined resolution(s) (or range of resolutions). In an embodiment, a user's credentials may authorize input of image data at a higher scan resolution, but limit authorization for scanning in color. As an example, a user may select for input a document comprising Level 2 impressions and a scan resolution of 600×600. Such parameters may be utilized for a user inputting a black and white document at a high resolution to capture line art or fine graphics, or a document or an image with small text information. The parameters and/or credentials used for defining the control tiers should not be limiting.

This disclosure provides an automatic way to provide the user with a maximum or a highest possible service based on at least their credentials. It does not delete a job if the required credentials (e.g., authorization) are not met; rather, it automatically inputs and scans the data based on the credentials. It reduces and/or eliminates a need for user input (e.g., to pick a second selection) to scan page(s). This is advantageous as users like to receive a maximum service that they can possibly get for their credentials, without having to navigate and figure out additional alternatives or options for inputting documents. It also allows the credentials to be a controlling factor for adjusting input image quality/color of a document to fit a particular user.

The methods illustrated in FIGS. 1-2 are exemplary embodiments showing automatic scanning of document(s) based on a user's credentials in accordance with this disclosure. However, such methods are not meant to be limiting. For example, in an embodiment, the selection of the highest tier (e.g., in block 106 of method 100) comprises receiving a user's selection for input of the document at a specific tier (i.e., the credentials are defined by selection or features chosen). That is, a user may input via an interface (on the machine or via remote connection) features for inputting one or more documents (e.g., a specific documents or all documents associated with the user). For example, a user may define the scan resolution for a document to be input. The selected scan resolution may be used (alone or in combination with other features) to determine the first tier. Other features that a user may define for inputting a document may include a specific machine or device for scanning a document, an amount of colorant used in a document, a saturation level of color, a resolution for input and/or output of a document, brightness of hues of colors of the output image data, sharpness of pixels in the image data, contrast between pixels of the image data, and/or lightness/darkness of pixels of image data, for example. Again, one or all of these features may be used to determine the first selected tier(s). As such, the herein disclosed method may be applied such that if the user's selection(s) are not authorized, a next tier is selected and the image data is scanned according to the next tier. One or more features may be altered and selected. For example, if a user selects a third tier color scan and high image resolution (600×600), either or both of the scanned amount of color and image resolution may be reduced to second tier user-approved thresholds (e.g., 5 percent color and 400×400).

FIG. 3 illustrates an exemplary block diagram of image path 400 for inputting and processing image data using a system, device or image processing apparatus 403, such as an MFD. System 403 comprises an input device 408 for inputting documents as image data and at least one processor 404 for processing documents containing image data comprising a plurality of pixels according to the method 100 of FIG. 1.

More specifically, the system/device/apparatus 403 may comprise, among other devices, an input device (e.g., an image input terminal (IIT) or memory) 402, at least one processor or processing elements 404 and 410, a controller 405 for communicating with and controlling processor(s), a memory 406 and/or a storage device 408, and an output device (e.g., network, IOT) 414 and/or marking engine interface 412. The image path 400 of the system 403 may also include an examination element 418 and/or cost calculation element 420 which may be a part of the system 403 itself or in communication with the processing elements 404 and 410, for example. Generally, the above elements (as will be generally described) of the device are provided to perform functions that assist in automatically inputting image data (such as a scanned document) according to the selected highest tier for a user's credentials (whether it is the highest or next highest selection), and optionally configuring the image path of the processing elements 404 and 410 (and possibly elements 418 and 420) to process the image data, and optionally outputting the image data by printing (or copying) a document. However, it should be noted that the apparatus or device may comprise additional elements not described herein or alternative elements for performing similar functions, and should not be limited to those elements as illustrated in FIG. 3. Generally, the image path shown in FIG. 3 corresponds to any number of output modes that may be selected for an image processing apparatus, system, or device. The elements in the image path 400 are further described in the incorporated '686 application noted below.

The input device 402 is used to scan image data of the document. In some embodiments, the input device 402 is used to scan or acquire an input document or page into image data, such as when scanning a document at a selected tier, for example, according to disclosed method. The input device 402 may be a digital scanner, for example. In an embodiment, the input device 402 may comprise the at least one processor and/or a controller for implementing method 100 and/or method 200. The input device 402 may be a part of the system or device. Generally, any device used to scan or capture the image data of a document for an image processing apparatus may be used. The input device 402 may include submission of electronic data by any means and should not be limiting. In other embodiments, the input device 402 may be an electronic device for inputting electronic image data. In some embodiments, input device 402 may be connected to a network 422 or telephone system, for example, to receive as input image data such as via a server 424 or personal computer (CPU) 426. Input documents and/or image data that is received electronically may be received via a telephone number, an e-mail address, an Internet Protocol (IP) address, a server, or other methods for sending and/or receiving electronic image data. For example, a separate input device or machine (e.g., a scanner) may scan image data and send the scanned image data to system 403 over network 422 such that the document is received. The network 422 may be a digital network such as a local area network (LAN), a wide area network (WAN), the Internet or Internet Protocol (IP) network, broadband networks (e.g., PSTN with broadband technology), DSL, Voice Over IP, WiFi network, or other networks or systems, or a combination of networks and/or systems, for example, and should not be limited to those mentioned above. The document may be input and/or received via electronic mail (email), HTTP/FTP server, or other electronic device to an electronic device for receipt (e.g., customer PC 426).

In an embodiment, a user interface for inputting credentials and/or threshold(s) for scanning documents is associated with input device 402. In another embodiment, a customer PC 426 may be used to input credentials and/or threshold(s) for scanning documents.

In any case, image data, such as image data for an original document 10, may be received or input via the input device 402.

The input device 402 delivers image data of a document to the system 403 and/or processing elements in the image path, so that the image data may optionally be saved or stored (e.g., in storage 408, or processed for output via output device 414).

FIG. 3 also shows a processor or processing elements for processing and/or manipulating image data using a plurality of operations and/or processes, including those of the disclosed method. The description of the processing elements below is an example of devices capable of implementing processes to be performed and should not be limiting. For example, additional or less processing elements may be provided along the image path 400. Alternatively, additional operations may be performed on the image data other than or in addition to those described with reference to FIG. 3. A controller 405 (e.g., microcontroller) may be provided in the image path to communicate with and to control elements of the system, including input device 402 and its features or settings for inputting (scanning) a document.

The image path 400 of system 403 may comprise a plurality of image processing elements (or processor) for manipulating image data received from the input device 402 using a plurality of operations and/or processes. The processing elements may be a combination of image processing elements which comprise software and hardware elements that perform a number of operations on the image data received from the input device 402 (e.g., IIT/scanner, memory, or other source) using a set of parameters. The parameters are used to convert the images for output (e.g., at highest color quality) along the image path. The processing elements may be a part of a computer system, device, or apparatus such as a xerographic system, a photocopier, a printing device, or a multi-function device (MFD). For simplicity purposes, the term “processing element” and “processor” throughout the application will refer to one or more elements capable of executing machine executable program instructions. It is to be understood that any number of processing elements may be used and that additional operations or processes besides those described below may be provided in an image path. Each of the image processing elements comprises an input and an output. Additionally, the system, device, or apparatus may also include one or more routers (not shown) to select and route the image data between the processing elements and other elements, for example.

More specifically, the image path of FIG. 3 comprises a front end processing element 404, a memory 406, storage 408, and a back end processing element 410. Each of the devices or elements in the image path may be in communication with each other and with controller 405, as represented by path 407. The use of processing elements such as front and back end processing elements 404 and 410 for processing image data is generally known in the art (for example, color space conversion, rendering, etc.) and therefore is not described in detail herein.

In an embodiment, the front end processing element 404 is an image processing element that receives input image data in an image path. The back end processing element 410 is generally used at the end of an image path to retrieve stored image data and to process the image data such that the image data may be output to a printing device as an accurate recreation of the original input or scanned image and in accordance with the highest color and quality output for the specific user, for example. Of course, processing elements may also be used for compression and/or decompression of image data.

In an embodiment, a processor such as front end processing element 404 and/or controller 405 may be used to receive and process user credentials and to select a highest tier for scanning image data. For example, the processing element 404 may be configured to communicate with input device 402 and may receive credentials, select a highest tier for scanning image data, and scan image data using the input device 402 as described in the above methods and embodiments.

In an embodiment, one or more of the elements (e.g., processing elements 404, 410, controller 405 and/or memory 406/storage 408) of system 403 may be connected to communication network 422 or telephone system, for example, for communication with other devices, systems, or apparatuses. For example, in some cases, image data, user credentials, or executable instructions may be provided via a server 424 or a computer (CPU) 426 connected to the network 422. As further described below, in a possible embodiment, at least one processing element of system 403 may implement an operative set of processor executable instructions (with or without controller 405) in accordance with the herein disclosed methods 100 and 200.

Memory 406 and/or storage 408 may be used to store image data. For example, memory 406 and/or storage 408 may be used to temporarily store the original image data of document input via input device 402. Memory 406 and/or storage 408 may be used to store machine readable instructions to be executed by the input device, processor/processing elements, and, in an embodiment, may store one or more user credential(s) for inputting or scanning documents. The memory 406 and/or storage 408 may be implemented using static or dynamic RAM (random access memory), a floppy disk and disk drive, a writable optical disk and disk drive, a hard disk and disk drive, flash memory, or the like, and may be distributed among separate memory components. The memory 406 and/or storage 408 can also include read only memory, or other removable storage drive(s) or memory devices.

The front end processing element 404 may communicate with memory 406 and/or storage 408 of system/apparatus 400 to store processed and/or compressed image data, for example. Compressed image data may be stored in memory 406 and/or storage 408 temporarily or for a later time when needed. When the image data is needed or it is time for marking (e.g., using the marking engine interface 412 or output device/terminal 414), the image data may be retrieved from memory 406 and/or storage 408 via the back end processing element 410 to export the image data that has been scanned, for example. In an embodiment, the image data may be retrieved and further processed for output.

In an embodiment, the image data may be processed and may be directly output to the marking engine interface 412 for printing using an output device/terminal 414. In another embodiment, the image data is further processed by the processor(s) before being output to marking engine interface 412 and output device 414. The marking engine interface 412 and/or output device 414 may be associated with a printer or MFD which is used for printing documents. In some cases, the marking engine interface may be a part of the output device 414.

In an embodiment, the marking engine interface 412 may be designed to receive reconstructed and processed image data to send or output to the output device 414 (e.g., printer) for a copy or print job. The marking engine interface 412 may further perform image processing on the image data to make corrections or compensate for deviation in the printing process. Alternatively, the back end processing element 410 may be used to perform further image processing on the image data.

The marking engine interface 412 outputs processed image data to the output device 414 for outputting the image data of the document. The type of output device 414 should not be limiting. For example, the output device 414 may comprise an image output terminal (IOT), printing device, copying device, MFD, or other devices.

It should be noted that the output print quality of image data from an output device 414 such as a MFD may depend on the type of system or device (and its available output modes/resolution). For example, an output device with multiple print or copy quality modes (standard, enhanced, expressive, high resolution/photo, etc.), each which may have a different resolution, are supported. Additionally, each may be a part of the user credentials and/or used to select a tier (a highest or a next highest one) at which a document is inputted or scanned. Of course, these modes are just an example of modes that may be used for printing using the output device 414, and, therefore, should not be limiting.

As also illustrated in FIG. 3, in accordance with an embodiment, the system 403 may further comprise one or more elements for selecting/determining a billing structure and/or a billing cost for inputting a page or document via an input device such as device 408. For example, a tiered billing structure may be used with system 403. Additionally or alternatively, the one or more elements may select/determine a billing structure and/or a billing cost for outputting a page or document via an output device such as device 414. For example, as shown in FIG. 3, an examination element 418 and/or cost calculation element 420 may be provided. In an embodiment, the examination element 418 and/or cost calculation element 420 may be a part of the system 403. In an embodiment, the elements 418 and/or 420 are separate from the image path of the system 403. In an embodiment, the features, calculations, selections, and/or determinations provided by examination element 418 and/or cost calculation element 420 may be incorporated into one or more processing elements, such as elements 404, 410, or 412, and therefore such elements should not be limited to the illustrated embodiment. Operations and methods implemented by elements 418, 419, and 420 via computer-readable media are described in further detail in the incorporated '002 application noted above.

Also, as previously mentioned, it is envisioned that an embodiment in accordance with this disclosure may include a system 403 that utilizes a network connection 422 for receiving user credentials, parameters, and thresholds, and/or receiving image data of a document scanned according to a selected tier using an input device. The network may include any type of network such as the Internet, Wi-Fi, DSL, local area network (LAN), or wide area network (WAN), for example. In an embodiment, a customer may input and view (via a display device) information on CPU 426 that is connected to network 422, either by communicating directly with system 403 or by instructing system 403 to access retrieved information (e.g., profile credentials) from a server 424 (also connected network 422). For example, a user may queue threshold(s) for scanning using an input device 402, while using an interface that is separate therefrom. Once a customer submits a job (e.g., document) and his profile/credentials (e.g., via a website), for example, the job is scanned automatically using an input device 402 utilizing the disclosed method(s) such as method 100.

In some cases, a user interface (UI) may be provided directly on the output apparatus/device and/or CPU 426 (such as system 403), while in others a UI is provided as a separate electronic device. Besides for inputting or providing image data and/or user credentials, the UI may also display a user's credentials. For example, a user may view authorized tier(s). A user may also view features associated with inputting or outputting jobs (e.g., tier at which a job was input, cost for outputting a job) via the UI.

The interface may be used to input credentials for a specified user, input parameter(s) for inputting a document, or both. In an embodiment, two interfaces may be provided. A system may have its own interface, while another interface is also provided for input. For example, the interface of the system may be used to enter input parameters for inputting a document (e.g., scan resolution, color level, etc.), while the another interface is used to enter user credentials. Such embodiments are not meant to be limiting.

Although the system referenced in FIG. 3 describes a system that may include multi-functional features (e.g., input, processing, and output), it should be noted that the herein described method and an image capture device for capturing image data should not be limited to a system or machine configured for printing, copying, or the like. In accordance with an embodiment of this disclosure, an “input device” or “image input terminal” can include any kind of image recording device, such as a digital camera or other photographic device capable of recording images. Thus, a “document” can also or alternately include any set of related images, such as for recording a moving image. For example, in an embodiment, a camera may have limited storage with a common storage space associated therewith (either directly or indirectly, e.g., via a network connection). Thus, user credentials may be used in accordance with control tiers to limit use of, storage in, and/or file sizes within the common storage space. Such tiers may include the features noted above (e.g., resolution, color image data), as well as other camera settings, for example.

As such, the herein disclosed methods and system offer a number of improvements over prior methods for inputting image data. In particular, the methods provide usage limits for scanning (inputting) documents. The method also provide an automatic approach to scan input document(s) to a maximum tier, (as determined by the controller and/or processor(s)). They further provide users with improved productivity by enabling scanning and optionally printing/copying at the best image quality level (e.g., color output) without requiring much user input.

It also provides a greater control over color usage. For example, in one way it offers users/customers an ability to provide color usage limits through a tiered plan. For example, features for scanning documents may be authorized/restricted according to each individual user (e.g., seniority) or according to time. In an environment wherein an authorized time may be added to a user's credentials, the disclosed method provides some flexibility for scanning documents. For example, scan usage and parameters may be centrally controlled by a system administrator or department, such as in an office environment. A system administrator may determine the one or more authorized tiers associated with each user's credentials. Such information may be accessed, edited, and saved in a server such as server 424, for example. In an embodiment, the administrator or department may limit color scanning (i.e., tiers) by using a timing system. For example, the tiers may be defined by a time of day (e.g., each tier comprises a set time period). This can help an administrator control the bandwidth of the network while scanning. As an example, due to increase in scanning and resolutions in devices and machines (e.g., 600 dpi high resolution scanning), system administration can become heavy and bogged down. Sometimes, administrators may be tempted to and/or implement limiting scanning to black and white scanning and/or turning off scanning capabilities completely. The disclosed methods 100 and 200, however, provide an opportunity to maximize the usage of scanning under restricted conditions. For example, U.S. Pat. No. 6,972,857 to Mantell, issued Dec. 6, 2005, which is hereby incorporated by reference in its entirety, describes methods which may be used to limit or alter resolution, color, and other such features (or thresholds) in the disclosed methods, in accordance with embodiments. Any number of methods for controlling and/or limiting scanning may be used with this disclosure.

Also, as previously disclosed, scanning restrictions can be further expanded to allow users to scan higher resolution/color/quality scans during particular times (e.g., “off hours”) (e.g., before 10:00 a.m. or after 7:00 p.m.) to reduce the scan resolution/color/quality during normal business hours. This allows users to be limited to scanning at a lower bandwidth (e.g., ‘Tier 1’ scans) at times of larger network traffic. The users may also be presented with the option of scanning at a different time (as shown in FIG. 4) at a higher bandwidth.

Moreover, providing control in scanning as noted in the disclosed methods 100 and 200 could limit users from scanning a job at greater than certain scan resolution, color mode/saturation/level, or scan only at a certain quality level (e.g., JPEG compression level or MRC compression) for which they are authorized or permitted. Otherwise, users can be restricted to certain scan feature sets (tiers) according to their directory service profiles, and the scanning features are automatically altered for input. Alternatively, a system administrator or department can centrally control network bandwidth generated with network scanning features, saving both administrative time and resources. Such features need not be implemented based on individual sites, specific input devices or machines, and/or a customer environment, for example. In some instances, the system implementing the disclosed methods comprises a system administrator configuration for setting policies at each individual site according to a customer's environment.

In today's cost conscious office environment, some flexibility and control of scanning documents is key to reduction in costs. The disclosed methods assist in reducing such costs. This disclosure can also help improve productivity of users and provide a way for administrators to control access to particular machines (e.g., MFD), input device(s), and/or output devices.

According to an embodiment of the disclosure, the scanning and processing of image data is provided in response to the processing elements of system 803 executing one or more sequences of one or more instructions contained in a memory (e.g., memory 806). Such instructions may be read into the memory from another computer-readable medium, such as a storage device (which may or may not be a part of the memory). Execution of the sequences of instructions contained in the memory causes processing elements to perform the process steps of method 100 and/or 200 as described herein. One or more processors in a multi-processing arrangement may also be employed to execute the sequences of instructions contained in the memory of the system 403. However, the embodiments of this disclosure are not limited to any specific combination of hardware and/or software.

The term “computer-readable medium” as used herein refers to any product or medium that participates in providing instructions to processor(s) for execution. Such a medium may take many forms, including but not limited to, non-volatile media, volatile media, and transmission media. Common forms of computer program products or readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other product from which a computer can read. Also, various forms of computer products or media may be involved in carrying one or more sequences of one or more instructions to processor(s) for execution, and should not be limiting.

The methods for automatic scanning may be used or considered for billing a customer. Input scan features—e.g., color scans, scan resolution—may contribute to the cost and/or the output image. It is envisioned to be within the scope this disclose that the described tiered scan limits may be used to determine a billing structure for scanning and copying a document. In order to categorize types of images and any costs associated with outputting images, a billing structure may be determined and/or selected based on the type of image. The input features and characteristics may affect the billing structure for outputting image data. For example, a billing structure is a method by which a charge for printing a document is calculated. The billing structure may include a plurality of factors, which are not disclosed in detail herein (see the incorporated '686 Application, noted below, for some examples).

In an embodiment, the billing structure is based on a multi-tiered threshold value. The multi-tiered threshold value may be determined using a number of factors (e.g., a color coverage ratio, percentage of color to a page/document, percentage of colorant (ink/toner) for marking, percentage of color pixels, etc.). Based on such factors, the page or document may be billed by choosing a billing structure associated with a tier (e.g., Tier-1, Tier-2, Tier-3) based on a number of satisfied threshold(s). Such multi-tier bill plans provide options to the customer which better match types of printed (or copied) documents and workflows. Thresholds for billing tier may be selected from one or more of the following group: a percentage amount of color in the document (which can include: a percentage amount of color for output, a percentage amount of color for marking, and/or a percentage of color pixels), an amount of colorant used to output the document, and a saturation level of color, for example. In an embodiment, tiers may be divided into a 3-tier threshold billing structure such as disclosed in U.S. patent application Ser. No. 12/580,686, entitled “System and Method for Determining a Billing Structure for Documents Based on Color Coverage of Marked Color Pixels,” filed Oct. 16, 2009, hereby incorporated by reference in its entirety—i.e., expressive, useful, and everyday color use.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will be appreciated that various of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

What is claimed is:

1. A method for automatically scanning documents comprising at least one page for a specified user using an image processing apparatus, the image processing apparatus comprising an image input terminal for scanning documents into image data and a processor for processing documents containing image data comprising a plurality of pixels, the processor configured to perform the method comprising:
receiving credentials for a specified user;
selecting a highest tier for scanning image data from a plurality of tiers and based on credentials for the specified user, each tier being based on at least one predetermined threshold, and
scanning the image data according to the at least one predetermined threshold of the selected highest tier using the image input terminal.

2. The method according to claim 1, wherein the image processing apparatus is interconnected with at least one electronic device for communication over a communication network; the image processing apparatus further comprising an output device for outputting documents, and wherein the method further comprises: processing the image data and outputting the processed image data of the document to the electronic device via the communication network.

3. The method according to claim 1, wherein the credentials comprise authorization for scanning documents at one or more predetermined tiers from the plurality of tiers, and wherein the selecting the highest tier of the method further comprises:
comparing the authorization to the selected highest tier to determine if scanning at the selected highest tier is authorized.

4. The method according to claim 3, wherein the credentials comprise authorization to scan at a predetermined tier based on a time of day.

5. The method according to claim 4, wherein if the comparison results in scanning being unauthorized for scanning of the image data at the selected highest tier because the time of day is unauthorized, then the method further comprises:
determining an authorized time of day for scanning the image data at the selected highest tier, and
providing the authorized time of day to the user.

6. The method according to claim 3, wherein if the comparison results in scanning being unauthorized for scanning of the image data at the selected highest tier, then the method further comprises:
selecting a next highest tier using the processor from the plurality of tiers for scanning the image data that is authorized and based on the authorization of the credentials, and
scanning the image data of the document according to the at least one predetermined threshold of the selected next highest tier using the image input terminal.

7. The method according to claim 6, wherein the selection of the next highest tier comprises selecting a tier with a lesser range of percentage amounts of color than a range of percentage amounts of color in the selected highest tier.

8. The method according to claim 6, wherein the selection of the next highest tier comprises selecting a tier with a lesser resolution than a resolution in the selected highest tier.

9. The method according to claim 6, wherein the at least one predetermined threshold for each tier is based on a resolution for scanning the document, and wherein the scanning comprises scanning the image data with a lesser resolution than a resolution for the selected highest tier using the image input terminal.

10. The method according to claim 8, wherein the scanning of the image data according the selected next highest tier further comprises one or more of the following steps: adjusting hues of colors of the image data, adjusting sharpness of pixels of the image data, adjusting contrast between pixels of the image data, and/or adjusting saturation of one or more colors.

11. The method according to claim 1, wherein the at least one predetermined threshold for each tier may be selected from one or more of the following group: a percentage amount of color, a saturation level of color, and a scan resolution.

12. The method according to claim 1, wherein the selection of the highest tier comprises receiving a user's selection for scanning the document at a specific tier.

13. The method according to claim 6, wherein the selection of the highest tier and/or the selection of the next highest tier is further based on one or more of the following group: a current time period selected from a plurality of predetermined time periods, a time of day, a day of the week, and a current network bandwidth.

14. A system for automatically scanning documents comprising at least one page for a specified user, the system comprising:
an image input terminal for inputting documents as image data; and
processor for processing documents containing image data comprising a plurality of pixels,
wherein the processor is configured to:
receive credentials for a specified user;
select a highest tier for scanning image data from a plurality of tiers and based on credentials for the specified user, each tier being based on at least one predetermined threshold, and
scan the image data according to the at least one predetermined threshold of the selected highest tier using the image input terminal.

15. The system according to claim 14, wherein the system is interconnected with at least one electronic device for communication over a communication network; the system further comprising an output device for outputting documents, wherein the processor is further configured to process the image data and wherein the output device is configured to output the processed image data of the document to the electronic device via the communication network.

16. The system according to claim 14, wherein the credentials comprise authorization for scanning documents at one or more predetermined tiers from the plurality of tiers, and wherein the processor is further configured to:
compare the authorization to the selected highest tier to determine if scanning at the selected highest tier is authorized.

17. The system according to claim 16, wherein the credentials comprise authorization to scan at a predetermined tier based on a time of day.

18. The system according to claim 17, wherein if the comparison results in scanning being unauthorized for scanning of the image data at the selected highest tier because the time of day is unauthorized, then the processor is further configured to:
determine an authorized time of day for scanning the image data at the selected highest tier, and
provide the authorized time of day to the user.

19. The system according to claim 16, wherein if the comparison results in scanning being unauthorized for scanning of the image data at the selected highest tier, then the processor is further configured to:
select a next highest tier using the processor from the plurality of tiers for scanning the image data that is authorized and based on the authorization of the credentials, and
scan the image data of the document using the image input terminal.

20. The system according to claim 19, wherein the selection of the next highest tier comprises selecting a tier with a lesser range of percentage amounts of color than a range of percentage amounts of color in the selected highest tier.

21. The system according to claim 19, wherein the at least one predetermined threshold for each tier is based on a resolution for scanning the document, and wherein the scanning comprises scanning the image data with a lesser resolution than a resolution for the selected highest tier using the image input terminal.

22. The system according to claim 14, wherein the at least one predetermined threshold for each tier may be selected from one or more of the following group: a percentage amount of color, a saturation level of color, and a scan resolution.

23. The system according to claim 14, wherein the selection of the highest tier is based on a user's selection for scanning the document at a specific tier.

24. The system according to claim 19, wherein the selection of the highest tier and/or the selection of the next highest tier is further based on one or more of the following group: a current time period selected from a plurality of predetermined time periods, a time of day, a day of the week, and a current network bandwidth.
